(19) United States
(12) Patent Application Publication
(10) Pub. No.: US 2014/0341008 A1
(43) Pub. Date: Nov. 20, 2014

(54) TESTING DEVICE AND TESTING METHOD FOR TESTING PERFORMANCE PARAMETER OF DISC PLAYER

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: PENG-FEI WANG, Shenzhen (CN); DONG-YAN LI, Shenzhen (CN); BING ZHOU, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/279,335

(22) Filed: May 16, 2014

(30) Foreign Application Priority Data
May 17, 2013 (CN) 2013101831559

(51) Int. Cl. G11B 20/18

(52) U.S. Cl. CPC G11B 20/1816
USPC 369/53.37

(57) ABSTRACT

A testing device for testing performance parameters of a disc player includes a display, and a storage that records a plurality of types of different discs, a plurality of testing commands each corresponding to a type of discs, and a reference value range of each of performance parameters of the disc player. The testing command corresponding to the type of a disc is obtained to be executed by the disc player to obtain a value of each performance parameter of the disc player. The testing device determines whether the disc player is qualified or not according to the obtained value.

### FIELD

The present disclosure relates to testing technologies in relation to electronic devices, and more particularly to a testing device and a method capable of automatically obtaining performance parameters of a disc player.

### BACKGROUND

During production of a disc player, performance parameters of the disc player are obtained to detect whether the disc player is qualified or not. In a typical test method, a number of different types of discs are used to test the disc player. Generally, when the disc player reads data from the different types of discs, the performance parameters of the disc player is different.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic block diagram of an embodiment of a testing device for obtaining performance parameters of a disc player.

FIG. 2 is a flowchart of an embodiment of a testing method for obtaining the performance parameters of the disc player using the testing device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software commands, written in a programming language, for example, Java, C, or assembly. One or more software commands in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage system. Embodiments of the present disclosure will be described with reference to the drawings.

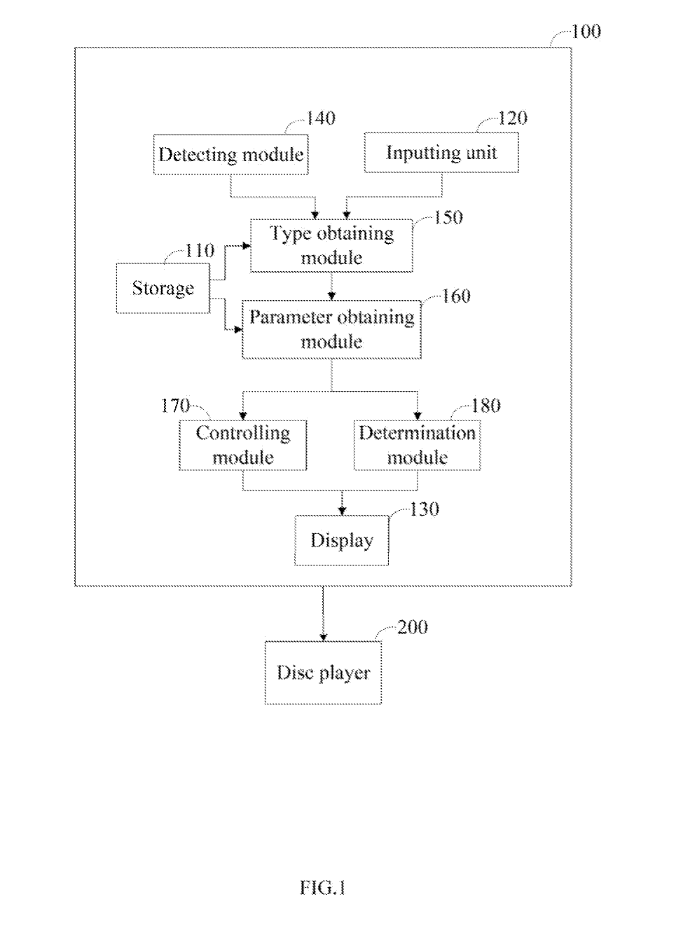

FIG. 1 illustrates a schematic block diagram of an embodiment of a testing device 100. The testing device 100 is configured to obtain one or more performance parameters of a disc player 200. The testing device 100 can be an independent device or a component integrated in the disc player 200.

The testing device 100 includes a storage 110, an inputting unit 120, a display 130, a detecting module 140, a type obtaining module 150, a parameter obtaining module 160, a determination module 170, and a control unit 1.

The storage 110 records a plurality of different types of discs, a plurality of testing commands each corresponding to a type of disc, and a reference value range of each of performance parameters of the disc player 200. Each testing command is configured to activate one or more testing operations. The disc player 200 can execute the testing operation. The reference value range of each performance parameter of the disc player 200 is associated with a type of disc. In the present embodiment, the disc can be a digital video disc (DVD), a compact disc (CD), or a blue-ray disc (BD).

The inputting unit 120 can be a keyboard, a mouse, a touch screen, a touch pad, or a barcode scanner, for example, to receive manual operations.

The display 30 displays can be a liquid crystal display (LCD), a light emitting diode (LED) display, or other like display devices.

The type obtaining module 140 detects a type of disc when the disc is put into the disc player 200 to be tested. In the present embodiment, the type obtaining module 140 reads data of the disc to detect the type of disc. In the other embodiments, the type of disc can be manually input from the inputting unit 120, and the type obtaining module 140 can obtain the type of disc from the inputting unit 120.

The detecting module 150 detects whether the disc player 200 is in a to-be-tested state or not. In the present embodiment, the disc player 200 generates a to-be-tested command when the disc player 200 is prepared to be tested. If the to-be-tested command is detected, the disc player 200 is determined to be in the to-be-tested state.

When the disc player 200 is in the to-be-tested state, the parameter obtaining module 160 obtains at least one testing command corresponding to the type of disc from the storage 110, and controls the disc player 200 to execute the at least one testing command. Then, the parameter obtaining module 160 obtains a value of each performance parameter of disc player 200.

The control module 170 controls the display 130 to display the value of each performance parameter of the disc player 200.

The determination module 180 determines whether the obtained value of each performance parameter of the disc player 200 is within the reference value range of the corresponding performance parameter. When the value of each performance parameter is within the reference value range, the control module 170 controls the display 130 to display a first prompt message indicating that the disc player 200 is qualified. When the value of at least one performance parameter is not within the reference value range, the control module 170 controls the display 130 to display a second prompt message indicating that the disc player 200 is not qualified.

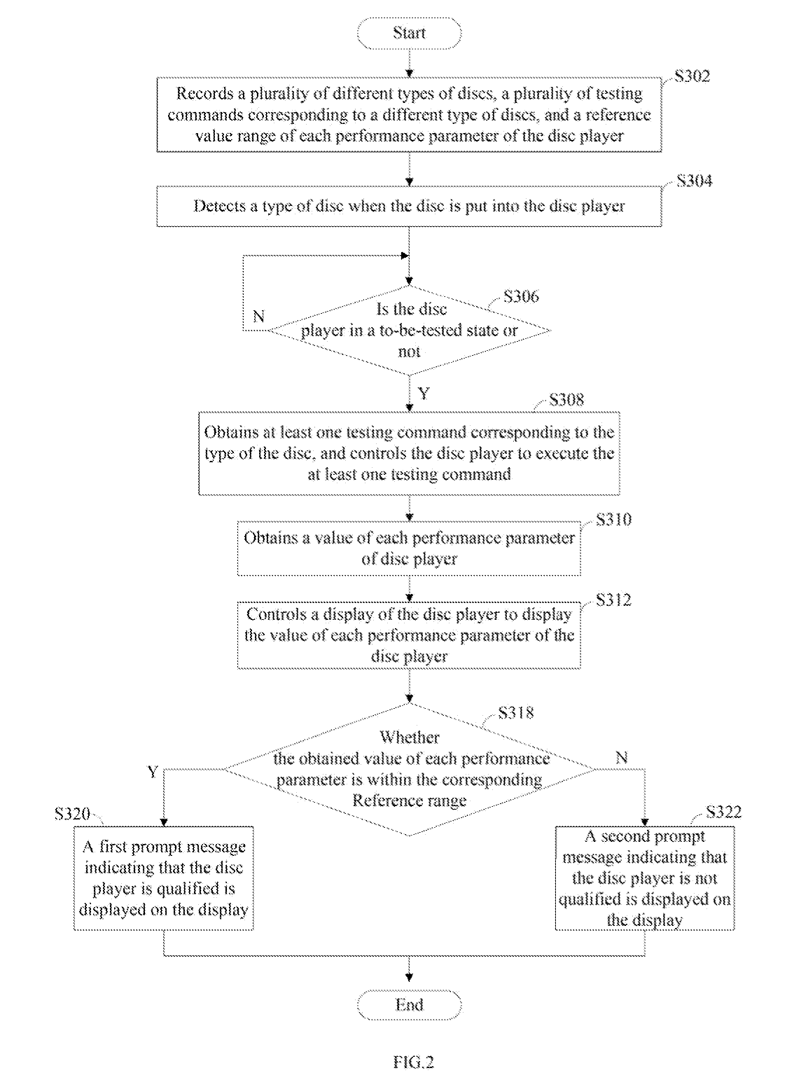

FIG. 2 illustrates a testing method implemented by the testing device 100 to test a disc player 200. Depending on the embodiment, additional steps may be added, others removed, and the ordering of the steps may be changed.

In block 302, the storage 110 records a plurality of different types of discs, a plurality of testing commands corresponding to a different type of disc, and a reference value range of each performance parameter of the disc player. Each testing command is configured to activate one or more testing operations. The disc player 200 can execute the testing operation. The reference value range of each performance parameter of the disc player 200 is associated with a type of disc.

In block 304, the type obtaining module 140 detects a type of disc when the disc is put into the disc player 200. In the present embodiment, the type obtaining module 140 reads data of the disc in order to detect the type of disc.

In block 306, the detecting module 150 detects whether the disc player 200 is in a to-be-tested state or not. In present embodiment, the disc player 200 generates a to-be-tested command when the disc player 200 is prepared to be tested. If the to-be-tested command is detected, the disc player 200 is determined to be in the to-be-tested state, block 308 is implemented. If the to-be-tested command is not detected, the detecting module 150 repeats the to-be-tested command.

In block 308, the parameter obtaining module 160 obtains at least one testing command corresponding to the type of the disc, and controls the disc player 200 to execute the at least one testing command

In block 310, the parameter obtaining module 160 obtains a value of each performance parameter of disc player 200.

In block 312, the control module 170 controls a display 130 to display the value of each performance parameter of the disc player 200

In block 314, the determination module 180 determines whether the obtained value of each performance parameter of the disc player 200 is within the reference value range of the corresponding performance parameter. When the value of each performance parameter is within the reference value range of the corresponding performance parameter, block 316 is implemented. When the value of each performance parameter is not within the reference value range of the corresponding performance, block 318 is implemented.

In block 316, a first prompt message indicating that the disc player is qualified is displayed on the display

In block 318, a second prompt message indicating that the disc player is not qualified is displayed on the display.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A testing device testing performance parameters of a disc player, the testing device, comprising:
a display;
a storage for recording a plurality of different types of discs, a plurality of testing commands each corresponding to a type of disc, and a reference value range of each of performance parameters of the disc player;
a type obtaining module for detecting a type of a disc which is put into the disc player;
a parameter obtaining module for obtaining at least one testing command corresponding to the type of the disc and controlling the disc player to execute the at least one testing command, and obtaining a value of each performance parameter of the disc player when the at least one testing command is executed by the disc player;
a determination module for determining whether the disc player is qualified or not by determining whether the obtained value of each performance parameter of the disc player is within the reference value range of the corresponding performance parameter;
a controlling module for controlling the display to display a message indicating whether or not the disc player is qualified via a display of the testing device.

2. The testing device as claimed in claim 1, wherein the controlling module is further used for controlling the display to display the obtained value of each performance parameter of the disc player.

3. The testing device as claimed in claim 1, wherein when the value of each performance parameter is within the reference value range of the corresponding performance parameter, the determination module is further used for controlling the display to display a first prompt message indicating that the display is qualified.

4. The testing device as claimed in claim 1, when the value of at least one performance parameter is not within the reference value range of the corresponding performance parameter, the determination module is further used for controlling the display to display a first prompt message indicating that the display is not qualified.

5. A testing method for testing performance parameters of a disc player using a testing device, the testing method comprising:
recording a plurality of different types of discs, a plurality of testing commands each corresponding to a type of disc, and a reference value range of each of performance parameters of the disc player, in a storage of the testing device;
detecting a type of a disc which is put into the disc player;
obtaining at least one testing command corresponding to the type of the disc and controlling the disc player to execute the at least one testing command;
obtaining a value of each performance parameter of the disc player when the at least one testing command is executed by the disc player;
determining whether the disc player is qualified or not by determining whether the obtained value of each performance parameter of the disc player is within the reference value range of the corresponding performance parameter; and
displaying a message indicating whether or not the disc player is qualified via a display of the testing device.

6. The testing method as claimed in claim 5, further comprising:
displaying the obtained value of each performance parameter of the disc player on the display.

7. The testing method as claimed in claim 5, wherein when the value of each performance parameter is within the reference value range of the corresponding performance parameter, a first prompt message indicating that the disc player is qualified is displayed on the display.

8. The testing method as claimed in claim 7, wherein when the value of at least one performance parameter of the disc player is not within the corresponding reference value range of the corresponding performance parameter, a second prompt message indicating that the disc player is not qualified is displayed on the display.

9. The testing method as claimed in claim 5, wherein the type of the disc is manually input by an inputting device of the testing device.

10. The testing method as claimed in claim 5, wherein the type of the disc is obtained according to data read from the disc.
